(19) United States
(12) Patent Application Publication
(10) Pub. No.: US 2015/0140677 A1
(43) Pub. Date: May 21, 2015

(54) POLYMER PLANAR OPTICAL CIRCUIT TYPE DISSOLVED OXYGEN SENSOR

(71) Applicant: Electronics and Telecommunications Research Institute, Daejeon (KR)

(72) Inventors: Jin Hwa RYU, Ulsan (KR); Kyu Ha BAEK, Daejeon (KR); Lee Mi DO, Daejeon (KR); Kang Bok LEE, Daejeon (KR)

(21) Appl. No.: 14/308,854

(22) Filed: Jun. 19, 2014

(30) Foreign Application Priority Data
Nov. 18, 2013 (KR) 10-2013-0139660

(51) Int. Cl. G01N 21/64; G01N 21/85

(52) U.S. Cl. CPC G01N 21/6428; G01N 21/8507; G01N 2021/6434; B29K 2101/00
USPC 436/138; 422/82.07; 427/157

(57) ABSTRACT

Provided is a polymer planar optical circuit type dissolved oxygen sensor and a method of fabricating the sensor, including a polymer planar sheet embedded with a first wavelength optical signal transmission line transmitting a first wavelength optical signal emitted from a first optical source and a second wavelength optical signal transmission line transmitting a second optical signal emitted from a sensing membrane and having a fluorescent property, and the sensing membrane coated on the polymer planar sheet, and further including a second optical source emitting the second wavelength optical signal to compare an optical property of the second wavelength optical signal to an optical property of the first wavelength optical signal emitted from the first optical source.

### CROSS-REFERENCE TO RELATED APPLICATION

This application claims the priority benefit of Korean Patent Application No. 10-2013-0139660, filed on Nov. 18, 2013, in the Korean Intellectual Property Office, the disclosure of which is incorporated herein by reference.

### BACKGROUND

1. Field of the Invention

The present invention relates to a polymer planar optical circuit type dissolved oxygen sensor and a method of fabricating the sensor, and more particularly, to a dissolved oxygen sensor in which a channel delivering an optical signal is embedded in a polymer planar sheet and a sensing membrane measuring dissolved oxygen is disposed on a surface of the polymer planar sheet.

2. Description of the Related Art

Dissolved oxygen is used as an important variable in various fields, for example, a field of maritime and fisheries, wastewater treatment, a fermentation process, food industries, and living environment related industries. The dissolved oxygen is used as a measure directly indicating a characteristic of water, and more particularly, as an index of environmental pollution.

Also, the dissolved oxygen is used as a means of health care for human beings. An oxygen concentration in blood may be used as a health care index because oxygen is delivered to cells and organs of human beings through the blood. Measurement of the dissolved oxygen applies a more advanced form of technology, for example, ranging from an electronic sensor to an optical sensor, for accuracy, durability, and safety.

An optical dissolved oxygen sensor may include an optical source, a sensing membrane, and an optical detector. The optical source may be used as an energy source to measure a concentration of dissolved oxygen and emit an optical signal having a wavelength. The sensing membrane may react with oxygen present in an environment to be measured. The sensing membrane may emit a fluorescent property as an optical signal having a different wavelength, as energy excited by selectively reacting with the optical signal having the wavelength arrives, from the optical source, is stabilized. The fluorescent property may be dependent on the concentration of oxygen present in the environment to be measured. The optical detector may measure the energy of the optical signal having the fluorescent property that reacts to the sensing membrane and is emitted from the sensing membrane, and measure the dissolved oxygen of the environment.

Such a conventional optical sensor may face issues of a systemic volume caused by integrating the optical source, the sensing membrane, and the optical detector, an optical loss caused by receiving and transmitting an optical signal in a system, and a limitation on processing time and costs incurred for optical alignment of the optical source, an optical waveguide, the sensing membrane, and the optical detector.

Accordingly, conducting research on a sensor capable of measuring dissolved oxygen that applies a simpler and higher efficient method with a low cost, is required.

### SUMMARY

According to an aspect of the present invention, there is provided a dissolved oxygen sensor including a polymer planar sheet embedded with an optical signal transmission line transmitting a first wavelength optical signal emitted from a first optical source and a second wavelength optical signal emitted from a sensing membrane and having a fluorescent property, and the sensing membrane to be coated on the polymer planar sheet. The sensing membrane may emit the second wavelength optical signal having the fluorescent property based on an oxygen concentration of a substance to be measured.

The optical signal transmission line may be formed by applying a resin onto a substrate having an optical property and curing the resin based on a form of an elastic body mold in contact with the substrate.

The resin may be an ultraviolet curable polymer material, and the elastic body mold may be a polydimethylsiloxane (PDMS) mold composed of PDMS.

An upper layer of the substrate may be coated on an opposite plane of the substrate of the polymer planar sheet with a polymer material having an identical optical property to the substrate.

At least a portion of the elastic body mold may be provided in a form of a “V” shape being formed at a 45 degree angle against the substrate.

A V-shaped portion on an optical signal transmission path cured based on the V shape of the elastic body mold may be plated with a metal layer to control a proceeding direction of the first wavelength optical signal and the second wavelength optical signal.

The sensing membrane may be coated with a solution including a ruthenium complex having a fluorescent property based on the oxygen concentration of the substance to be measured.

The dissolved oxygen sensor may further include a second optical source to emit the second wavelength optical signal to compare an optical property of the second wavelength optical signal to an optical property of the first wavelength optical signal emitted from the first optical source.

According to another aspect of the present invention, there is provided a method of fabricating a dissolved oxygen sensor including embedding, in a polymer planar sheet, an optical signal transmission line transmitting a first wavelength optical signal emitted from a first optical source and a second wavelength optical signal emitted from a sensing membrane and having a fluorescent property, and coating the sensing membrane on the polymer planar sheet. The sensing membrane may emit the second wavelength optical signal having the fluorescent property based on an oxygen concentration of a substance to be measured.

The embedding may include applying a resin onto a substrate having an optical property and included in the polymer planar sheet, and curing the resin based on an elastic body mold in contact with the substrate. The resin may be used as a material to fabricate the optical signal transmission line transmitting a predetermined wavelength optical signal and an optical signal having the fluorescent property.

The method of fabricating the dissolved oxygen sensor may further include coating, on an opposite plane of the substrate, an upper layer of the substrate with a polymer material having an identical property to the substrate.

The resin may be an ultraviolet curable polymer material, and the elastic body mold may be a polydimethylsiloxane (PDMS) mold composed of PDMS.

At least a portion of the elastic body mold may be provided in a form of a “V” shape being formed at a 45 degree angle against the substrate.

The coating of the upper layer of the substrate may include arranging a mask fabricated to allow only a V-shaped portion on an optical signal transmission path cured based on the V shape of the elastic body mold to be exposed, and disallow exposure of remaining portions of the elastic body mold to control a proceeding direction of the first wavelength optical signal and the second wavelength optical signal, and plating, with a metal layer, a surface of the V shape of the exposed optical signal transmission path.

The coating may be performed with a solution including a ruthenium complex having the fluorescent property based on the oxygen concentration of the substance to be measured.

According to still another aspect of the present invention, there is provided a method of measuring dissolved oxygen including allowing a first wavelength optical signal emitted from a first optical source to enter an optical signal transmission line embedded in a polymer planar sheet, allowing an optical signal transmission path of the first wavelength optical signal to be changed by a metal layer disposed in at least a portion of the optical signal transmission line, and allowing the first wavelength optical signal to reach a sensing membrane, allowing the sensing membrane to react with oxygen present in the substance to be measured and allowing the sensing membrane to emit a second wavelength optical signal having a fluorescent property, and allowing the second wavelength optical signal to reach an optical detector.

The metal layer may be provided in a form of a “V” shape being formed at a 45 degree angle against a substrate of a dissolved oxygen sensor.

The method of measuring the dissolved oxygen may further include emitting the second wavelength optical signal to compare an optical property of the second wavelength optical signal to an optical property of the first wavelength optical signal emitted from the first optical source.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a configuration of a conventional optical type dissolved oxygen sensor according to a related art;

FIG. 2 is a cross-sectional view illustrating a process of fabricating a polymer optical circuit based on an imprinting process according to an embodiment of the present invention;

FIG. 3 a diagram illustrating a structure of a polymer planar optical circuit type dissolved oxygen sensor according to an embodiment of the present invention;

FIG. 4 is a cross-sectional view illustrating a process of fabricating a polymer planar optical circuit type dissolved oxygen sensor according to an embodiment of the present invention;

FIG. 5 is a flowchart illustrating a method of fabricating a polymer planar optical circuit type dissolved oxygen sensor according to an embodiment of the present invention;

FIG. 6 is a flowchart illustrating a method of embedding an optical signal transmission line in a polymer planar sheet according to an embodiment of the present invention; and

FIG. 7 is a flowchart illustrating a method of measuring dissolved oxygen according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the accompanying drawings, however, the present invention is not limited thereto or restricted thereby.

When it is determined a detailed description related to a related known function or configuration that may make the purpose of the present invention unnecessarily ambiguous in describing the present invention, the detailed description will be omitted here. Also, terms used herein are defined to appropriately describe the exemplary embodiments of the present invention and thus may be changed depending on a user, the intent of an operator, or a custom. Accordingly, the terms must be defined based on the following overall description of this specification.

A detailed description of a polymer planar optical circuit type dissolved oxygen sensor according to exemplary embodiments of the present invention will be provided hereinafter. An optical sensor to be fabricated according to exemplary embodiments may apply planar optical circuit technology, polymer replication technology, and fluorescence technology. Currently, active research is being conducted on the planar optical circuit technology to process massive information at a high speed. In the research, a method of fabricating a planar optical circuit using polymer is garnering attention due to a low cost and a high efficiency. Also, an imprinting method is drawing a particular attention, among various methods of fabricating the planar optical circuit using polymer.

The imprinting method may include allowing a mold having a fine structure and polymer to be in a physical contact with each other and directly transferring a fine pattern. The imprinting method may be considered a next generation process technology in a field of micro/nano patterning technology due to a simple process, a short processing time, and a low processing cost. Hereinafter, a detailed description of a method of fabricating a polymer planar optical circuit type dissolved oxygen sensor will be provided with reference to figures.

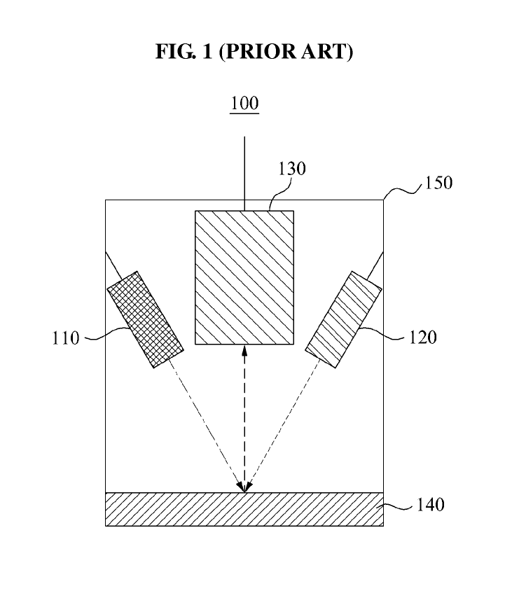

FIG. 1 is a diagram illustrating a configuration of a conventional optical dissolved oxygen sensor 100 according to a related art.

A first optical source 110 having a predetermined wavelength of the conventional optical dissolved oxygen sensor 100 may emit an optical signal to a sensing membrane 140 in contact with a measurement medium to measure a concentration of oxygen. The sensing membrane 140 may emit an optical signal having a fluorescent property based on the concentration of oxygen and an optical detector 130 may measure the emitted optical signal.

To secure reliability and accuracy of a result of the measurement, a second optical source 120 having a predetermined wavelength may emit an optical signal to the sensing membrane 140 in an identical manner to the first optical source 110 and the optical detector 130 may measure the optical signal reacting with the sensing membrane 140.

In general, the first optical source 110 may use a blue light emitting diode (LED) with a wavelength of 450 nanometers (nm). The sensing membrane 140 may be provided with a material having a fluorescent property towards an incident optical signal, and a ruthenium complex is currently used as a fundamental material for the sensing membrane 140. The ruthenium complex reacts with oxygen and emits a red light signal with a wavelength of 620 nm corresponding to a blue light signal with the wavelength of 450 nm.

An optical source with an identical wavelength to the optical signal having the fluorescent property that reacts with the sensing membrane 140 and is emitted from the first optical source 110 may be used as the second optical source 120. Optical signals reacting with the sensing membrane 140 by the first optical source 110 and the second optical source 120 may be respectively received by the optical detector 130.

Dissolved oxygen may be measured by collecting optical properties, for example, a phase difference between the two optical signals emitted from the first optical source 110 and the second optical source 120, and correcting environmental variables, for example, temperature and pressure.

The sensing membrane 140 may have one plane exposed to and in contact with an external environment of the measurement medium. The first optical source 110, the second optical source 120, the optical detector 130, and the sensing membrane 140 may be provided in a form of a probe embedded in a case 150 to be isolated from the external environment.

However, such a type of the optical dissolved oxygen sensor 100 may face challenges in terms of a systemic volume caused by integration of the optical sources, the sensing membrane 140, and the optical detector 130 and a limitation on processing time, and costs incurred by optical alignment. A description of a process of fabricating an optical circuit based on an imprinting process, which is a polymer replication process designed to improve issues relating to the processing time and cost, will be provided hereinafter.

The process described hereinafter is provided only as an example used in the imprinting process to illustrate the present invention and is not to be construed as limited thereto, which may be obvious to those skilled in the art.

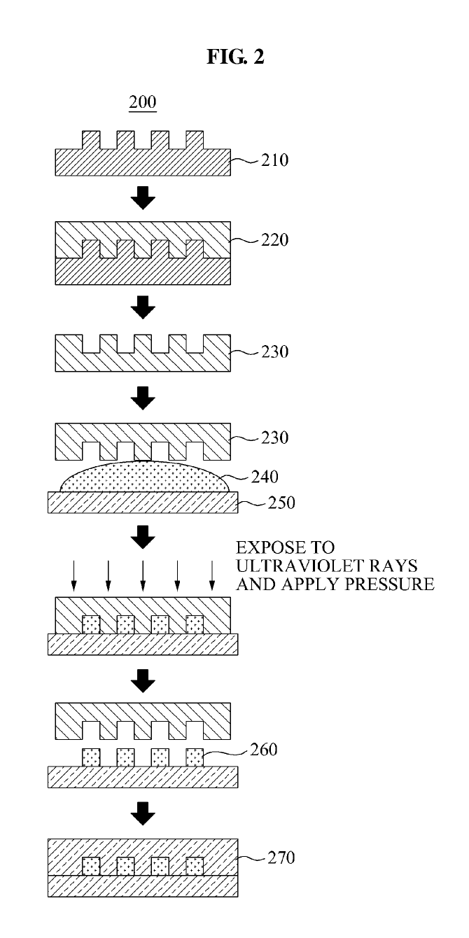

FIG. 2 is a cross-sectional view illustrating a process 200 of fabricating a polymer optical circuit based on an imprinting process according to an embodiment of the present invention.

The process 200 may be performed using a circle master 210 fabricated using a general method, for example, photolithography. Although the process 200 may be performed directly using the circle master 210, a process of fabricating an elastic body mold may be performed to prepare a replica mold having a desirable ultraviolet transmission for a lifespan of the circle master 210 and an ultraviolet exposure process.

The elastic body mold may be fundamentally provided with a polymer material, for example, Polydimethylsiloxane (PDMS) 220, for only an illustrative purpose and thus, the process 200 may not be limited thereto. When the PDMS 220 is applied in a liquid state to a surface of the circle master 210, the PDMS 220 may become in contact with all patterns of the circle master 210 due to fluidity of liquid. After a period of approximately one to four hours elapses at a temperature in an approximate range of 60° C. to 90° C., the PDMS 220 may be hardened from the liquid state, and a PDMS mold 230 having an elastic property may be formed.

The formed PDMS mold 230 may be simply separated from the circle master 210 due to a low surface energy and the elastic property. A process of fabricating a core layer 260, which is an optical signal transmission line, using the PDMS mold 230 will be described hereinafter.

The core layer 260 may be fabricated by applying an ultraviolet curable polymer resin 240 onto a substrate 250 having an optical property. Subsequently, a pressure in a range of one to five bars may be applied to allow the PDMS mold 230 and the substrate 250 to be in contact with each other, and the resin 240 may fill in cavities of the PDMS mold 230.

Subsequently, an exposure process may be performed by allowing an ultraviolet ray to penetrate the PDMS mold 230 thereby, allowing the resin 240 to be exposed to the ultraviolet ray. Thus, the resin 240 in a liquid state may be cured to be in a solid state through photopolymerization.

The PDMS mold 230 may be simply separated from the patterns of the core layer 260 due to the low surface energy and the elastic property. The substrate 250 on which the core layer 260 is formed may perform a function as a lower clad layer.

Also, when an upper layer is coated with a polymer material having an identical refractive index to the substrate 250 performing the function as the lower clad layer, an upper clad layer 270 of an optical circuit layer may be formed. The substrate 250 performing the function of the lower clad layer and the upper clad layer 270 may prevent an optical loss that may be caused when an optical signal deviates from the optical signal transmission line and escapes outside.

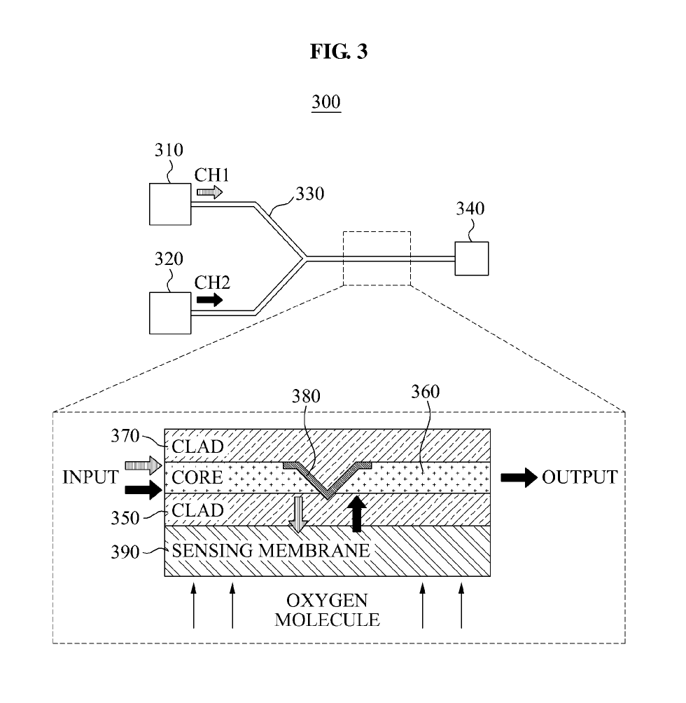

FIG. 3 is a diagram illustrating a structure 300 of a polymer planar optical circuit type dissolved oxygen sensor 330 according to an embodiment of the present invention.

An upper portion of FIG. 3 illustrating the structure 300 of the sensor 330 is a plan view of the sensor 330, and a lower portion marked in a dotted line is a cross-sectional view of a sensing unit by which dissolved oxygen is measured.

Although the sensor 330 is illustrated as a 2×1 planar optical circuit structure, the structure 300 of the sensor 330 is only provided as an illustrative example and thus, is not limited to such a structure.

A blue light signal with a wavelength of 450 nm emitted from a first optical source 310 may enter a channel 1 (CH 1) of the sensor 330. When the blue light signal entering CH 1 reaches a metal mirror plane 380 disposed at a 45 degree angle against a core layer 360 of the sensing unit, a transmission path of the blue light signal may be changed to a 90 degree direction. The blue light signal of which a direction is changed to the 90 degree direction may pass through a lower clad layer 350 and proceed down to a perpendicular direction.

When the blue light signal reaches a sensing membrane 390 emitting a fluorescent property by reacting with oxygen, a red light signal with a wavelength of 620 nm may be emitted. Also, the fluorescent signal having dissolved oxygen information may pass the lower clad layer 350 in a perpendicular direction and be reflected by the 45 degree metal mirror plane 380. Accordingly, a direction of the fluorescent signal may be changed to the 90 degree direction. The fluorescent signal whose direction is changed to the 90 degree direction may proceed towards the core layer 360 of the sensing unit and reach an optical detector 340.

Here, when the optical signal escapes, an optical loss may arise. To prevent the optical loss, an upper clad layer 370 may be disposed on the core layer 360, which is the optical signal transmission path, and thus, the upper clad layer 370 may perform a function of preventing the optical signal from escaping.

To improve accuracy and reliability of the sensor 330, an optical signal emitted from a second optical source 320 may enter a channel 2 (CH2) of the sensor 330. A proceeding path of the entered optical signal may be guided identically to a proceeding path of the optical signal of CH 1.

The second optical source 320 may use a red light source having a wavelength of 620 nm and be used as a reference optical source to compare an optical property of the optical signal emitted from the second optical source 320 to an optical property of the optical signal emitted from the sensing membrane 390 by the first optical source 310.

The sensor 330 may be designed to have the metal mirror plane 380 on the core layer 360, through which the sensing membrane 390 may be exposed to and in contact with an external environment of a measurement medium to be measured by the sensor 330.

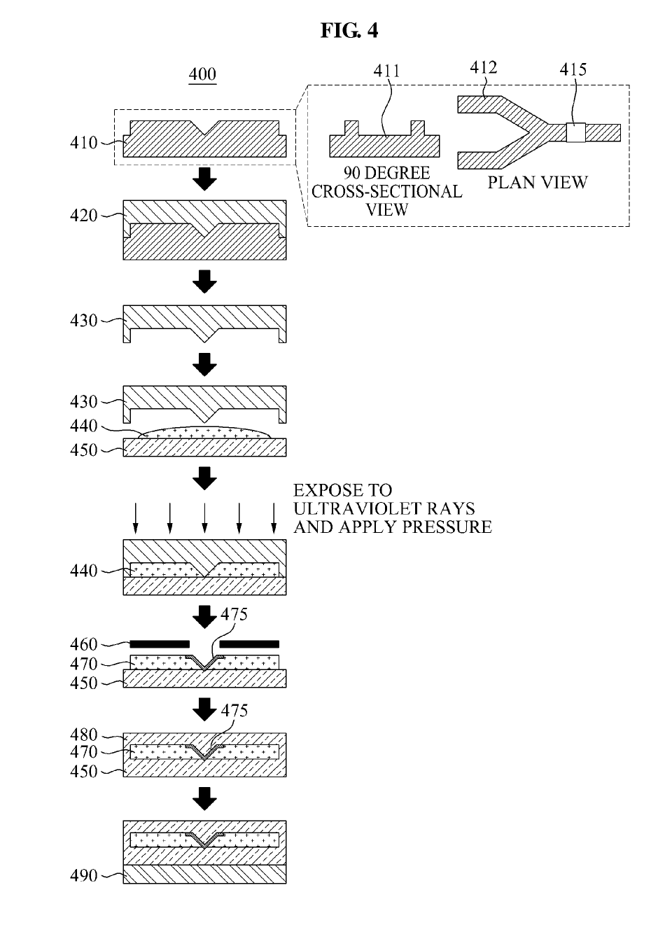

As described with reference to FIG. 2, in addition to the optical signal transmission path, the sensing unit may be fabricated to prevent the optical signal from escaping by designing a path of the optical signal not to be changed in the core layer 360 and the optical signal to be continuously transmitted through the core layer 360. A process of fabricating the sensing unit will be described with reference to FIG. 4.

FIG. 4 is a cross-sectional view 400 illustrating a process of fabricating a polymer planar optical circuit type dissolved oxygen sensor according to an embodiment of the present invention.

The cross-sectional view 400 is shown based on a direction of an optical signal proceeding path. Descriptions and drawings provided with reference to FIG. 4 will focus on the optical signal proceeding path.

Here, a 90 degree direction cross-sectional view 411 and a plan view 412 of a circle master 410 are additionally provided to facilitate an ease of understanding. Other 90 degree cross-sectional views and plan views of each step of the process, except for the cross-sectional view 411 and the plan view 412, will be omitted here to avoid repetition because each step of the process may be performed in an identical structure.

According to an embodiment, the circle master 410 may be fabricated through a conventional photolithography process and a reactive ion etching (RIE) process. Also, a structure 415 of a sensing unit provided in a form of a “V” shape being formed at a 45 degree angle against a substrate 450 may be fabricated through a V-sawing process using a V-shaped diamond blade.

Although, as described with reference to FIG. 2, the process of fabricating the polymer planar optical circuit type dissolved oxygen sensor may be performed directly using the circle master 410, an elastic body mold may be fabricated to prepare a replica mold having a desirable ultraviolet transmission in consideration of a lifespan of the circle master 410 and an ultraviolet exposure process. Also, the elastic body mold may be fundamentally composed of PDMS, but is not limited to such a material.

A process of forming a PDMS replica mold 430 to fabricate the polymer planar optical circuit type dissolved oxygen sensor will be described hereinafter.

The process of forming the PMDS replica mold 430 may be as follows. A PDMS solution 420 may be applied in a liquid state to a surface of the circle master 410. When the PDMS solution 420 in the liquid state comes in contact with all structures of the circle master 410 and is left at a temperature in an approximate range of 60° C. to 90° C. for a period of approximately one to four hours, the PDMS solution 420 may be hardened to form the PMDS replica mold 430 having an elastic property. The formed PDMS mold 430 may be simply separated from the circle master 410 due to a low surface energy and the elastic property.

A process of preparing an optical circuit to fabricate the polymer planar optical circuit type dissolved oxygen sensor to which an imprinting process using the formed PDMS mold 430 is applied will be described hereinafter. However, the process will be provided only as an illustrative example and thus, the present invention may not be limited to the following process, which may be obvious to those skilled in the art.

To prepare the optical circuit, a resin 440 may be applied onto a substrate 450 to be used as a lower clad layer. The substrate 450 may have an optical property and be included in a polymer planar circuit sheet. The resin 440 may be an ultraviolet curable polymer material.

After the resin 440 is applied onto the substrate 450, a pressure of one to five bars may be applied to allow the PDMS mold 430 and the substrate 450 functioning as the lower clad layer to be in contact with each other. When the pressure of one to five bars is applied, the resin 440 may fill in only cavities of the PDMS mold 430.

When the resin 440 is the ultraviolet curable polymer material, an exposure process through which the resin 440 may be exposed to an ultraviolet ray may be performed for seconds. Subsequently, the resin 440 in a liquid state may be cured to be in a solid state through photopolymerization. However, the foregoing process is provided only as an illustrative example, and other methods of curing a resin may be applied based on a characteristic of the resin, which is obvious to those skilled in the art.

After the resin 440 is cured to be in the solid state, the PDMS mold 430 may become separable. The PDMS mold 430 may be simply separated from patterns of the core layer 470 due to the low surface energy and the elastic property.

After the PDMS mold 430 is separated from the core layer 470, a mask 460 that may be prepared to allow exposure of only a V-shaped portion of the core layer 470 and disallow exposure of remaining portions of the core layer 470 may be arranged to control an optical signal proceeding direction.

The mask 460 may be arranged to plate only the V-shaped portion of the core layer 470 with a metal layer 475. When the metal layer 475 is plated on the remaining portions of the core layer 470 from which the V-shaped portion is excluded, the optical signal proceeding direction may be affected thereby and thus, the arrangement of the mask 460 may prevent such an influence.

The metal layer 475 plated on the V-shaped portion of the core layer 470 may be also formed to be at a 45 degree angle against the substrate 450 because the circle master 410 and the PDMS mold 430 may be fabricated to be at the 45 degree angle against the substrate 450 functioning as a lower clad layer.

The metal layer 475 may perform a function as a mirror capable of controlling the optical signal proceeding direction to be changed to an orthogonal direction. In general, the metal layer 475 may be plated with gold.

When an upper layer is coated with a polymer material having an identical reflective index to the substrate 450 functioning as the lower clad layer, an upper clad layer 480 of an optical circuit layer of a sensing unit may be formed. A process of forming the optical circuit layer functioning as an optical signal transmission path is described with reference to FIG. 2, although the description is not about the sensing unit. The sensing unit may further require a process of fabricating a sensing membrane 490 to measure dissolved oxygen of a measurement medium. A process of fabricating the sensing membrane 490 will be described hereinafter.

According to an embodiment, the sensing membrane 490 may be coated on the optical circuit layer to be formed. The sensing membrane 490 may be formed by coating with a solution including a ruthenium complex having a fluorescent property based on a concentration of oxygen.

As described above, a polymer planar optical circuit type dissolved oxygen sensor may improve issues that may be discovered in a conventional optical dissolved oxygen sensor. The issues may include a volume occupied by the sensor in a full system, and a processing time and cost. A highly integrated and a highly efficient sensor capable of measuring dissolved oxygen may be fabricated by improving the issue and applying a low cost and simpler method.

According to an embodiment, the polymer planar optical circuit type dissolved oxygen sensor may be fabricated to be in a structure in which an optical signal transmission line transmitting an optical signal emitted from a first optical source and an optical signal emitted from a second optical source, and a fluorescent signal emitted from a sensing membrane, and the sensing membrane are embedded and layered in a polymer planar sheet.

According to an embodiment, an optical alignment process required to fabricate an optical sensor may be omitted, and a passive alignment may be applicable. Also, a method of fabricating the optical sensor through a simple polymer replication process and at a low cost may be provided. The passive alignment may refer to an alignment method by which dimensional and structural alignment are automatically performed and thus, an additional optical alignment may not be required.

Hereinafter, the method of fabricating the polymer planar optical circuit type dissolved oxygen sensor will be described in greater detail by focusing on an optical circuit layer functioning as an optical signal transmission line.

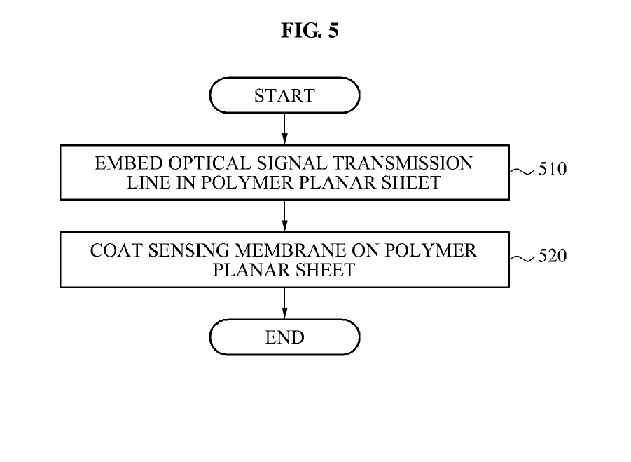

FIG. 5 is a flowchart illustrating a method of fabricating a polymer planar optical circuit type dissolved oxygen sensor according to an embodiment of the present invention.

In operation 510, an optical signal transmission line may be embedded in a polymer planar sheet. The optical signal transmission line of an optical signal with a predetermined wavelength emitted from at least one optical source and an optical signal having a fluorescent property and emitted from a sensing membrane may be embedded in the polymer planar sheet.

Prior to performing operation 510, the optical source may be preferentially provided in the polymer planar optical circuit type dissolved oxygen sensor. Based on the provided optical source, an optical circuit layer functioning as the optical signal transmission line may be disposed suitably to a characteristic of an optical signal circuit.

Also, an optical detector used to detect an optical property of the optical signal may be provided and fabricated so that the optical signal emitted from the optical source may be detected, by the optical detector, through the optical circuit layer functioning as the optical signal transmission line.

In operation 520, the sensing membrane may be coated on the polymer planar sheet. According to an embodiment, a sensing unit may be limited to a predetermined portion of the optical signal transmission line or be formed over an entirety of the optical signal transmission line.

When the sensing unit is designed to be limited to the predetermined portion of the optical signal transmission line, a process of coating the sensing membrane on the polymer planar sheet may not be applied to remaining portions of the optical signal transmission line from which the sensing unit is excluded.

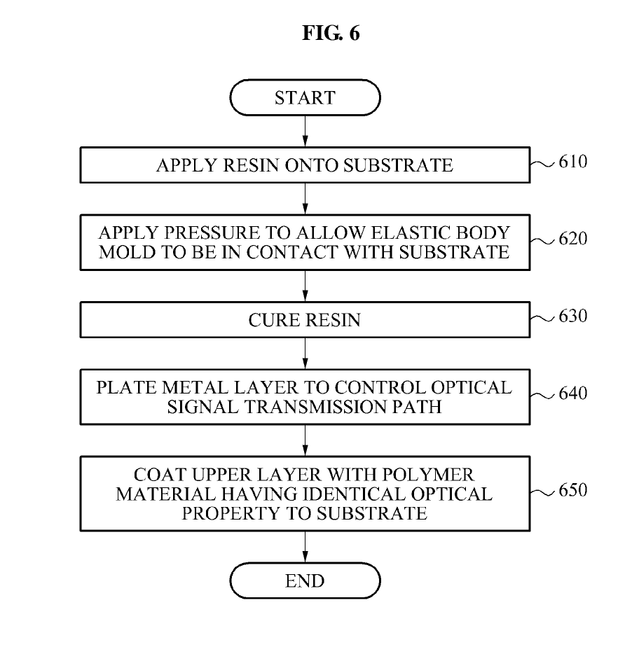

A detailed description of the operation of embedding the optical signal transmission line in the polymer planar sheet will be provided with reference to FIG. 6.

FIG. 6 is a flowchart illustrating a method of embedding an optical signal transmission line in a polymer planar sheet according to an embodiment of the present invention.

In operation 610, a resin may be applied to a substrate. According to an embodiment, the resin may be applied to the substrate having an optical property and included in the polymer planar sheet. The resin may be used as a material to fabricate an optical signal transmission line of an optical signal with a predetermined wavelength emitted from an optical source and an optical signal having a fluorescent property and emitted from a sensing membrane.

In operation 620, pressure may be applied to allow an elastic body mold and the substrate to be in contact with each other. The elastic body mold may be fabricated to have a V shape for the sensing unit. For other portions that are simply used as the optical signal transmission line, the elastic body mold may be fabricated for the resin functioning as the optical signal transmission line not to be disconnected and thus, the optical signal may not escape.

In operation 630, the resin may be cured based on a form of the elastic body mold. Based on the form of the elastic body mold, the resin functioning as the optical signal transmission line may be cured to be a solid state from a liquid state. Here, the elastic body mold may be differently fabricated based on whether the elastic body mold is used for the sensing unit or simply for the optical signal transmission line. Thus, the resin may be differently cured for the sensing unit or the optical signal transmission line based on the form of the elastic body mold.

In operation 640, a metal layer may be applied to control an optical signal transmission path. The metal layer may perform a function of controlling the optical signal transmission path. The metal layer may be formed at an angle of 45 degrees against the substrate and thus, the metal layer may perform the function as a mirror capable of controlling an optical signal proceeding direction to be changed to a 90 degree direction.

In operation 650, an upper layer may be coated with a polymer material having an identical optical property to the substrate functioning as a lower clad layer. The upper layer may function as an upper clad layer and prevent an optical loss caused when an optical signal escapes.

Detailed descriptions of a process and a method of fabricating a polymer planar optical circuit type dissolved oxygen sensor provided with reference to FIGS. 5 and 6 are the are identical to descriptions provided with reference to FIGS. 2 through 4 and thus, repeated descriptions will be omitted here for conciseness.

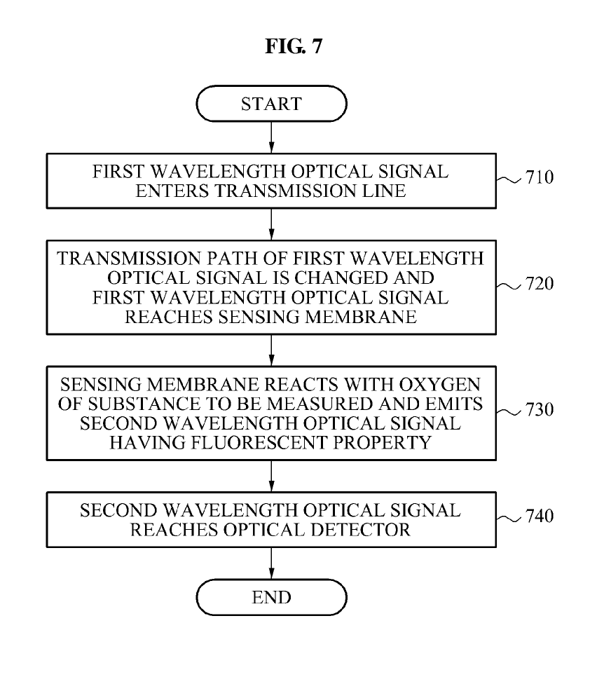

FIG. 7 is a flowchart illustrating a method of measuring dissolved oxygen according to an embodiment of the present invention.

In operation 710, a first wavelength optical signal emitted from a first optical source may enter an optical signal transmission line embedded in a polymer planar sheet. The first wavelength optical signal may be a blue light signal with a wavelength of 450 nm emitted from the first optical source through a channel 1 (CH 1). The first wavelength optical signal may proceed through the optical signal transmission line and not be lost outside by an upper clad layer and a lower clad layer until an optical signal transmission path is changed.

In operation 720, the transmission path of the first wavelength optical signal may be changed by a metal layer and thus, the first wavelength optical signal may reach a sensing membrane. When the first wavelength optical signal reaches the metal layer while the first wavelength optical signal is proceeding through the transmission path, the transmission path of the first wavelength optical signal may be changed. When the metal layer is provided in a form of a “V” shape being formed at a 45 degree angle against a substrate of the polymer planar sheet, the first wavelength optical signal may be reflected by the metal layer and the transmission path may be changed to a 90 degree direction.

In operation 730, after the first wavelength optical signal reaches the sensing membrane, the sensing membrane may react with oxygen of a substance to be measured and emit a second wavelength optical signal having a fluorescent property. The sensing membrane may be coated with a solution including a ruthenium complex having the fluorescent property based on a concentration of oxygen of the substance to be measured.

In operation 740, the second wavelength optical signal having the fluorescent property and dissolved oxygen information on the substance may reach an optical detector. The second wavelength optical signal may be analyzed to measure dissolved oxygen. To improve accuracy and reliability in measuring the dissolved oxygen, a second optical source may emit an optical signal with an identical wavelength to the second wavelength optical signal. The second wavelength optical signal emitted from the second optical source may be used as a reference optical source to compare an optical property of the second wavelength optical signal to an optical property of the first wavelength optical signal.

The above-described exemplary embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A dissolved oxygen sensor, the sensor comprising:
a polymer planar sheet embedded with an optical signal transmission line used to transmit a first wavelength optical signal emitted from a first optical source and a second wavelength optical signal emitted from a sensing membrane, wherein the sensing membrane emits the second wavelength optical signal having the fluorescent property based on an oxygen concentration of a substance to be measured; and
the sensing membrane to be coated on the polymer planar sheet.

2. The sensor of claim 1, wherein the optical signal transmission line is formed by applying a resin onto a substrate having an optical property and curing the resin based on a form of an elastic body mold in contact with the substrate.

3. The sensor of claim 2, wherein the resin is an ultraviolet curable polymer material.

4. The sensor of claim 2, wherein the elastic body mold is a polydimethylsiloxane (PDMS) mold composed of PDMS.

5. The sensor of claim 2, wherein an upper layer of the substrate is coated on one plane of the substrate of the polymer planar sheet with a polymer material having an identical optical property to the substrate.

6. The sensor of claim 2, wherein at least a portion of the elastic body mold is provided in a form of a “V” shape being formed at a 45 degree angle against the substrate.

7. The sensor of claim 6, wherein a V-shaped portion on an optical signal transmission path cured based on the V shape of the elastic body mold is plated with a metal layer to control a proceeding direction of the first wavelength optical signal and the second wavelength optical signal.

8. The sensor of claim 1, wherein the sensing membrane is coated with a solution comprising a ruthenium complex having a fluorescent property based on the oxygen concentration of the substance to be measured.

9. The sensor of claim 1, further comprising:
a second optical source to emit an optical signal having an identical wavelength to the second wave length optical signal emitted from the sensing membrane to compare an optical property of the optical signal to an optical property of the first wavelength optical signal emitted from the first optical source.

10. A method of fabricating a dissolved oxygen sensor, the method comprising:
embedding, in a polymer planar sheet, an optical signal transmission line used to transmit a first wavelength optical signal emitted from a first optical source and a second wavelength optical signal emitted from a sensing membrane and having a fluorescent property, wherein the sensing membrane emits the second wavelength optical signal having the fluorescent property based on an oxygen concentration of a substance to be measured; and
coating the sensing membrane on the polymer planar sheet.

11. The method of claim 10, wherein the embedding comprises:
applying a resin onto a substrate having an optical property and comprised in the polymer planar sheet, wherein the resin is used as a material to fabricate the optical signal transmission line transmitting a predetermined wavelength optical signal and an optical signal having the fluorescent property; and
curing the resin based on an elastic body mold in contact with the substrate.

12. The method of claim 11, further comprising:
coating, on one plane of the substrate, an upper layer of the substrate with a polymer material having an identical property to the substrate.

13. The method of claim 11, wherein the resin is an ultraviolet curable polymer material.

14. The method of claim 11, wherein the elastic body mold is a polydimethylsiloxane (PDMS) mold composed of PDMS.

15. The method of claim 11, wherein at least a portion of the elastic body mold is provided in a form of a “V” shape being formed at a 45 degree angle against the substrate.

16. The method of claim 15, wherein the coating of the upper layer of the substrate comprises:
arranging a mask fabricated to allow only a V-shaped portion on an optical signal transmission path cured based on the V shape of the elastic body mold to be exposed and disallow exposure of remaining portions of the elastic body mold to control a proceeding direction of the first wavelength optical signal and the second wavelength optical signal; and
plating, with a metal layer, a surface of the V shape of the exposed optical signal transmission path.

17. The method of claim 10, wherein the coating is performed with a solution comprising a ruthenium complex having the fluorescent property based on the oxygen concentration of the substance to be measured.

18. A method of measuring dissolved oxygen, the method comprising:
allowing a first wavelength optical signal emitted from a first optical source to enter an optical signal transmission line embedded in a polymer planar sheet;
allowing an optical signal transmission path of the first wavelength optical signal to be changed by a metal layer comprised in at least a portion of the optical signal transmission line and allowing the first wavelength optical signal to reach a sensing membrane;
allowing the sensing membrane to react with oxygen in the substance to be measured and allowing the sensing membrane to emit a second wavelength optical signal having a fluorescent property; and
allowing the second wavelength optical signal to reach an optical detector.

19. The method of claim 18, wherein the metal layer is provided in a form of a “V” shape being formed at a 45 degree angle against a substrate of a dissolved oxygen sensor.

20. The method of claim 18, further comprising:
emitting an optical signal having an identical wavelength to the second wave length optical signal emitted from the sensing membrane to compare an optical property of the optical signal to an optical property of the first wavelength optical signal emitted from the first optical source.
